(19) United States
(12) Patent Application Publication
(10) Pub. No.: US 2026/0277258 A1
(43) Pub. Date: Sep. 17, 2026

(54) METHODS AND SYSTEMS FOR HEATING EMERGENCY REGULATION IN SMART CITIES BASED ON INTERNET OF THINGS LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/669,942

(22) Filed: May 6, 2026

(30) Foreign Application Priority Data
Apr. 8, 2026 (CN) 202610450297.4

(51) Int. Cl. G05D 23/19; G05D 16/20; G05D 23/30

(52) U.S. Cl. CPC G05D 23/1917; G05D 16/2073; G05D 23/1904; G05D 23/30

(57) ABSTRACT

Disclosed herein are a method and a system for heating emergency regulation in a smart city based on an Internet of Things (IoT) large model. The system includes an emergency supervision and management platform. The emergency supervision and management platform is configured to: obtain heating parameters of a heating pipeline network to construct a heating variation vector; determine whether at least one of an abnormal heat exchange station or an abnormal pipeline terminal exists in combination with an ambient temperature; in response to determining that at least one of the abnormal heat exchange station or the abnormal pipeline terminal exists, determine a heat exchange abnormality type according to the heating variation vector; control at least one of a heating pipeline valve or a circulation pump to perform heating based on at least one of an updated valve opening of the heating pipeline valve or an updated rotation speed of the circulation pump; determine a heating correlation feature according to a plurality of historical variation vectors, and predict a potential abnormal area at a future time point in combination with the heating variation vector; and determine an adjustment time point according to the potential abnormal area, and control the heating pipeline valve and the circulation pump in a secondary network within the potential abnormal area to perform heating based on a secondarily adjusted valve opening and a secondarily adjusted rotation speed at the adjustment time point.

### CROSS-REFERENCE TO RELATED APPLICATIONS

This application claims priority to Chinese Patent Application No. 202610450297.4, filed on Apr. 8, 2026, the entire contents of which are incorporated herein by reference.

### TECHNICAL FIELD

The present disclosure generally relates to a field of city heating regulation technology, and in particular to a method and a system for heating emergency regulation in a smart city based on an Internet of Things (IoT) large model.

### BACKGROUND

A heating system is an important component of urban infrastructure. A heating pipeline network in a city often suffers from heating imbalance in actual operation due to a plurality of factors such as design defects, construction problems, and dynamic changes in user load. The heating imbalance may cause some areas to overheat due to excessive flow, while other areas may have insufficient heating due to insufficient flow. The heating imbalance seriously affects overall heating quality and causes huge energy waste. In traditional heating adjustment manners, technicians generally manually adjust parameters of a heating pipeline valve or a circulation pump to attempt to balance the heating system. The manner is not only inefficient but also difficult to adapt to complex and variable large-scale pipeline network systems.

Therefore, there is a need to provide a method and a system for heating emergency regulation in a smart city based on an Internet of Things (IoT) large model to improve adjustment efficiency of the heating system and achieve optimization of operation quality of the heating system.

### SUMMARY

One or more embodiments of the present disclosure provide a system for heating emergency regulation in a smart city based on an Internet of Things (IoT) large model. The system includes an emergency supervision and management platform. The emergency supervision and management platform is configured to execute a method for heating emergency regulation in a smart city based on the IoT large model.

One or more embodiments of the present disclosure provide a method for heating emergency regulation in a smart city based on an IoT large model. The method is executed by an emergency supervision and management platform of a system for heating emergency regulation in a smart city based on the IoT large model. The method includes: obtaining a plurality of groups of heating parameters of a heating pipeline network at a plurality of time points to construct a heating variation vector; determining whether at least one of an abnormal heat exchange station or an abnormal pipeline terminal exists according to the heating variation vector in combination with an ambient temperature of at least one of a heat exchange station or a residential area; in response to determining that at least one of the abnormal heat exchange station or the abnormal pipeline terminal exists, determining a heat exchange abnormality type according to the heating variation vector; updating at least one of a valve opening of a heating pipeline valve or a rotation speed of a circulation pump in a primary network or a secondary network according to the heat exchange abnormality type, and controlling at least one of the heating pipeline valve or the circulation pump to perform heating based on an updated valve opening and an updated rotation speed, the heating including at least one of conveying hot water by the heating pipeline valve or driving circulation of hot water by the circulation pump; determining a heating correlation feature according to a plurality of historical variation vectors; predicting a potential abnormal area at a future time point according to the heating variation vector and the heating correlation feature; and determining an adjustment time point according to the potential abnormal area, and controlling the heating pipeline valve and the circulation pump in the secondary network within the potential abnormal area to perform heating based on a secondarily adjusted valve opening and a secondarily adjusted rotation speed at the adjustment time point.

One or more embodiments of the present disclosure provide a non-transitory computer-readable storage medium storing computer instructions. When a computer reads the computer instructions in the storage medium, the computer executes a method for heating emergency regulation in a smart city based on an IoT large model described above.

### BRIEF DESCRIPTION OF THE DRAWINGS

The present disclosure is further described by way of exemplary embodiments, which are described in detail with reference to the accompanying drawings. These embodiments are not limiting, and in these embodiments, the same reference numerals denote the same structures, wherein:

FIG. 1 is a schematic diagram illustrating an exemplary platform structure of a system for heating emergency regulation in a smart city based on an Internet of Things (IoT) large model according to some embodiments of the present disclosure;

FIG. 2 is an exemplary flowchart illustrating a method for heating emergency regulation in a smart city based on an IoT large model according to some embodiments of the present disclosure;

FIG. 3 is a schematic diagram illustrating an exemplary heating graph structure according to some embodiments of the present disclosure;

FIG. 4 is a schematic diagram illustrating an exemplary process for determining an adjustment time point according to some embodiments of the present disclosure; and

FIG. 5 is an exemplary flowchart illustrating a process for performing a secondary adjustment on a valve opening and a rotation speed according to some embodiments of the present disclosure.

### DETAILED DESCRIPTION

To more clearly illustrate the technical solutions in the embodiments of the present disclosure, the accompanying drawings used in the description of the embodiments are briefly introduced below. Obviously, the accompanying drawings in the following description are merely some examples or embodiments of the present disclosure. For those of ordinary skill in the art, the present disclosure may be applied to other similar scenarios based on these accompanying drawings without creative efforts. Unless obviously obtained from the context or the context illustrates otherwise, the same numeral in the drawings refers to the same structure or operation.

It should be understood that the terms “system”, “unit”, and/or “module” used herein are methods for distinguishing different components, elements, parts, sections, or assemblies at different levels. However, if other words may achieve the same purpose, the words may be replaced by other expressions.

As shown in the present disclosure and the claims, unless the context clearly indicates an exception, the words “a”, “an”, “one”, and/or “the” are not intended to refer specifically to a singular number, and may also include a plural number. Generally, the terms “include” and “contain” only indicate that clearly identified steps and elements are included, and these steps and elements do not constitute an exclusive list. A method or device may also include other steps or elements.

The present disclosure uses flowcharts to illustrate operations performed by a system according to embodiments of the present disclosure. It should be understood that preceding or following operations are not necessarily performed precisely in order. Conversely, each step may be processed in reverse order or simultaneously. Meanwhile, other operations may be added to these processes, or one or more operations may be removed from these processes.

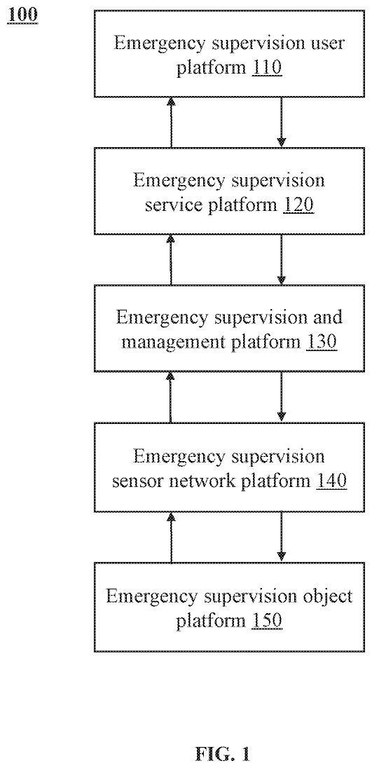

FIG. 1 is a schematic diagram illustrating an exemplary platform structure of a system for heating emergency regulation in a smart city based on an Internet of Things (IoT) large model according to some embodiments of the present disclosure.

In some embodiments, as shown in FIG. 1, a system 100 for heating emergency regulation in a smart city based on an IoT large model includes an emergency supervision user platform 110, an emergency supervision service platform 120, an emergency supervision and management platform 130, an emergency supervision sensor network platform 140, and an emergency supervision object platform 150.

The emergency supervision user platform 110 refers to a platform for interacting with a user.

In some embodiments, the emergency supervision user platform 110 may be configured as a terminal for use by a user.

The emergency supervision service platform 120 refers to a platform for communicating user requirements and control information.

In some embodiments, the emergency supervision service platform 120 may be configured as a server for communication.

In some embodiments, the emergency supervision service platform 120 may interact with the emergency supervision user platform 110 and the emergency supervision and management platform 130.

The emergency supervision and management platform 130 refers to a platform for generating supervision information and executing the control information.

In some embodiments, the emergency supervision and management platform 130 may be configured as a processor or a server that implements emergency regulation functions.

In some embodiments, the emergency supervision and management platform 130 is configured to execute a method for heating emergency regulation in a smart city based on the IoT large model.

The emergency supervision sensor network platform 140 refers to a platform for comprehensively managing sensing information.

In some embodiments, the emergency supervision sensor network platform 140 may be configured as a communication device or a server for communication, for example, a 5G base station, a Vehicle-to-Everything (V2X) roadside unit, a fiber optic switch, or the like.

In some embodiments, the emergency supervision sensor network platform 140 may interact with the emergency supervision and management platform 130 and the emergency supervision object platform 150.

The emergency supervision object platform 150 refers to a functional platform for generating the sensing information and executing the control information.

In some embodiments, the emergency supervision object platform 150 may include a heating pipeline valve and a circulation pump disposed at a heat exchange station, a thermal power plant, and a pipeline terminal.

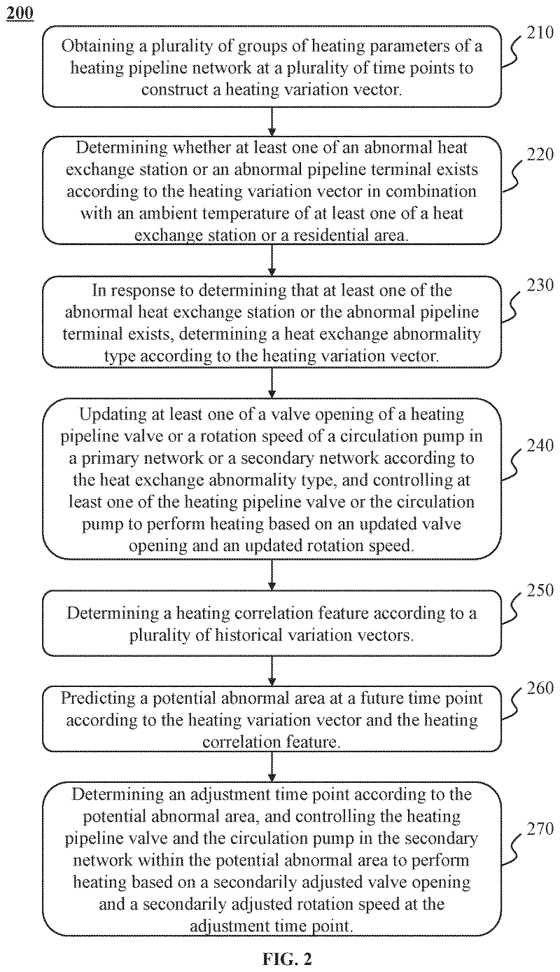

More details regarding the foregoing platforms may be found in other contents of the present disclosure (e.g., descriptions in connection with FIG. 2 to FIG. 5).

In some embodiments of the present disclosure, based on the system 100 for smart city heating emergency regulation based on the IoT large model, a closed loop of information operation among the functional platforms can be formed, thereby realizing informatization and intellectualization of heating emergency regulation.

FIG. 2 is an exemplary flowchart illustrating a method for heating emergency regulation in a smart city based on an IoT large model according to some embodiments of the present disclosure. In some embodiments, process 200 is executed by the emergency supervision and management platform. The process 200 includes the following operations.

In 210, a plurality of groups of heating parameters of a heating pipeline network may be obtained at a plurality of time points to construct a heating variation vector.

The heating pipeline network refers to a circulating heating system that transports thermal energy produced by a heat source to users through a pipeline system and returns return water to the heat source for reheating.

In some embodiments, the heating pipeline network may include a primary network and a secondary network.

The primary network refers to circulating heating pipelines between the heat source and heat exchange stations.

In some embodiments, the heat source includes a thermal power plant, or the like. The thermal power plant may heat hot water in the heating pipeline network to a preset temperature. It may be understood that the preset temperature is usually a relatively high temperature. The preset temperature may be preset by a technician based on experience.

The heat exchange stations refer to facilities arranged between the thermal power plant and users, configured to convert high-temperature and high-pressure water delivered from the thermal power plant into water with a lower temperature and pressure usable by the users.

In some embodiments, in the primary network, the thermal power plant is mechanically connected to a plurality of heat exchange stations through circulating heating pipelines.

The plurality of time points refers to a plurality of historical time points separated by a preset interval. For example, the plurality of time points may be consecutive historical time points separated by the preset interval within six hours before a current time point.

The secondary network refers to circulating heating pipelines between the heat exchange stations and the pipeline terminals of a residential area.

The residential area refers to an area where users of a heating system of a city are located. For example, the residential area includes a residential community, a factory building, or the like.

The pipeline terminals refer to parts of circulating heating pipelines that directly heat the residential area.

In some embodiments, in the secondary network, the heat exchange stations are mechanically connected to a plurality of pipeline terminals through the circulating heating pipelines.

In some embodiments, the heating parameters includes a heating temperature, a heating pressure, and a heating flow rate of the heat exchange station in the primary network, and a return water temperature, a terminal pressure, and a terminal flow rate of the pipeline terminal of the residential area in the secondary network. The heating temperature refers to a temperature of the hot water output by the heat exchange station. The heating pressure refers to a pressure of the hot water output by the heat exchange station. The heating flow rate refers to a flow rate of the hot water output by the heat exchange station. The return water temperature refers to a temperature of water output from the residential area. The terminal pressure refers to a pressure of the hot water at the pipeline terminal. The terminal flow rate refers to a flow rate of the hot water at the pipeline terminal.

The heating variation vector refers to a quantitative representation of a fluctuation state of the heating parameters.

In some embodiments, the emergency supervision and management platform may collect the plurality of groups of heating parameters of the heating pipeline network at the plurality of time points within a preset time period, and arrange values of each parameter in the plurality of groups of heating parameters at different time points according to parameter types to constitute the heating variation vector.

In 220, it may be determined whether at least one of an abnormal heat exchange station or an abnormal pipeline terminal exists according to the heating variation vector in combination with an ambient temperature of at least one of the heat exchange station or the residential area.

The ambient temperature refers to an air temperature of at least one of the heat exchange station or the residential area.

The abnormal heat exchange station refers to a heat exchange station with an operational abnormality that causes a decrease in heat transfer efficiency.

The abnormal pipeline terminal refers to a pipeline terminal with an operational abnormality that causes poor heating effect or a fault.

In some embodiments, the emergency supervision and management platform may determine whether at least one of the abnormal heat exchange station or the abnormal pipeline terminal exists in a plurality of ways according to the heating variation vector, in combination with the ambient temperature of at least one of the heat exchange station or the residential area. For example, the emergency supervision and management platform may determine whether an abnormal heat exchange station and/or an abnormal pipeline terminal exists according to a heating variation vector based on retrieval of a vector database.

The emergency supervision and management platform may construct a vector database based on historical data. The vector database includes a plurality of feature vectors and feature labels corresponding to the plurality of feature vectors. The emergency supervision and management platform may obtain historical heating temperatures, historical ambient temperatures, and historical heating flow rates when each heat exchange station and each pipeline terminal of each residential area are in a normal state, construct the plurality of feature vectors based on the foregoing parameters, obtain actual historical heating pressures, historical return water temperatures, historical terminal pressures, and historical terminal flow rates at a first historical time point corresponding to each feature vector, and use the actual historical heating pressures, the historical return water temperatures, the historical terminal pressures, and the historical terminal flow rates as the feature labels corresponding to each feature vector. The historical heating temperatures, the historical ambient temperatures, and the historical heating flow rates of each heat exchange station and each residential area in the normal state, and the actual historical heating pressures, the historical return water temperatures, the historical terminal pressures, and the historical terminal flow rates at the first historical time point, may be determined based on routine maintenance records of maintenance personnel.

The normal state refers to a state where an abnormality does not exist at the pipeline terminal of at least one of the heat exchange station or the residential area. It may be determined whether an abnormality exists at the pipeline terminal of at least one of the heat exchange station or the residential area at a historical time point based on routine maintenance records of maintenance personnel.

The first historical time point refers to a historical time point before the plurality of time points.

The emergency supervision and management platform may construct a target vector based on a heating temperature, a heating flow rate, and an ambient temperature in a heating variation vector at a current time point, determines vector similarities between the target vector and the plurality of feature vectors in the vector database, selects a plurality of feature vectors with vector similarities greater than a preset similarity threshold, and uses a range of the heating parameters of feature labels corresponding to the plurality of feature vectors as a normal range of heating parameters corresponding to the target vector. The preset similarity threshold may be preset by a technician based on experience.

The emergency supervision and management platform may compare the heating variation vectors of the pipeline terminals of each heat exchange station and each residential area with the normal range of the heating parameters. If a heating parameter in the heating variation vectors exceeds the normal range of the heating parameters, the emergency supervision and management platform determines that the heat exchange station is the abnormal heat exchange station or the pipeline terminal of the residential area is the abnormal pipeline terminal.

Two situations are known: a situation where at least one of the abnormal heat exchange station or the abnormal pipeline terminal exists, and a situation where at least one of the abnormal heat exchange station or the abnormal pipeline terminal does not exist.

In 230, in response to determining that at least one of the abnormal heat exchange station or the abnormal pipeline terminal exists, a heat exchange abnormality type may be determined according to the heating variation vector.

In some embodiments, the heat exchange abnormality type may include a heating temperature difference abnormality, a hot water flow abnormality, a hot water pressure abnormality, or the like. The heating temperature difference abnormality refers to a phenomenon where a temperature difference between the hot water and return water at the pipeline terminal deviates from a preset temperature difference range. The hot water flow abnormality refers to a phenomenon where at least one of an outlet flow rate or a return flow rate of at least one of the heat exchange station or the pipeline terminal deviates from a preset flow rate range. The hot water pressure abnormality refers to a phenomenon where at least one of an outlet pressure or a return pressure of at least one of the heat exchange station or the pipeline terminal deviates from a preset pressure range. The preset temperature difference range, the preset flow rate range, and the preset pressure range may be preset by a technician based on experience.

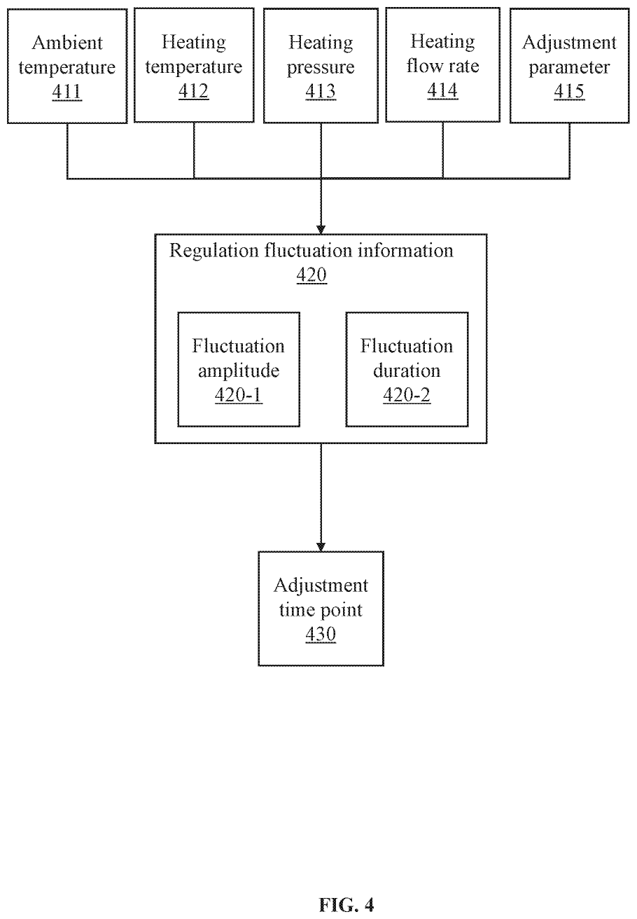

More details regarding the heat exchange abnormality type may be found in other contents of the present disclosure (e.g., descriptions in connection with FIG. 4).

In some embodiments, in response to determining that at least one of the abnormal heat exchange station or the abnormal pipeline terminal exists, the emergency supervision and management platform may determine the heat exchange abnormality type according to the heating variation vector through a plurality of ways. For example, the emergency supervision and management platform may compare the heating variation vector of each heat exchange station and each residential area with the normal range of the heating parameters. If the heating parameter outside the normal range of the heating parameters exists in the heating variation vector, the emergency supervision and management platform may determine the corresponding heat exchange abnormality type. For example, if the return water temperature is outside the normal range of the heating parameters, the emergency supervision and management platform may determine that the heating temperature difference abnormality exists. If the heating pressure or the terminal pressure is outside the normal range of the heating parameters, the emergency supervision and management platform may determine that the hot water pressure abnormality exists. If the terminal flow rate is outside the normal range of the heating parameters, the emergency supervision and management platform may determine that the hot water flow abnormality exists.

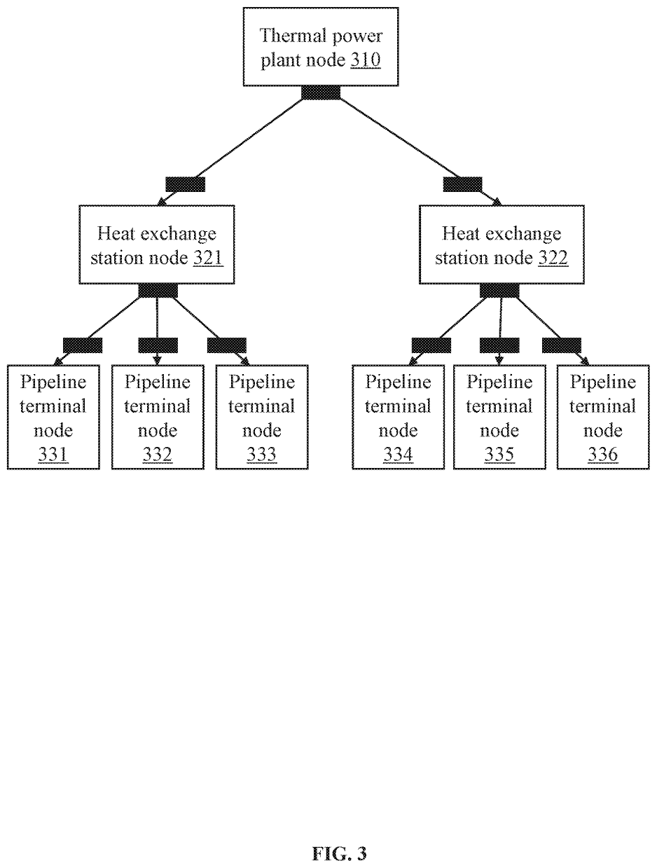

In some embodiments, the emergency supervision and management platform may also construct a heating graph structure to determine whether at least one of the abnormal heat exchange station or the abnormal pipeline terminal exists and to determine the heat exchange abnormality type. More details regarding the part may be found in other contents of the present disclosure (e.g., descriptions in connection with FIG. 3).

In 240, at least one of a valve opening of a heating pipeline valve or a rotation speed of a circulation pump in a primary network or a secondary network may be updated according to the heat exchange abnormality type, and at least one of the heating pipeline valve or the circulation pump may be controlled to perform heating based on an updated valve opening and an updated rotation speed.

Heating includes at least one of conveying the hot water by the heating pipeline valve or driving circulation of the hot water by the circulation pump.

The heating pipeline valve refers to a device disposed in a heating pipeline for regulating a circulation flow rate of the hot water in the heating pipeline.

The valve opening of the heating pipeline valve refers to an opening degree of the heating pipeline valve. The valve opening of the heating pipeline valve is proportional to the circulation flow rate of the hot water in the heating pipeline. For example, a larger valve opening of the heating pipeline valve results in a larger circulation flow rate of the hot water in the heating pipeline.

The circulation pump refers to a device disposed in a heating pipeline for driving water flow and regulating a circulation flow velocity of the hot water in the heating pipeline.

In some embodiments, the rotation speed of the circulation pump is proportional to the circulation flow velocity of the hot water in the heating pipeline. For example, a larger rotation speed of the circulation pump results in a larger circulation flow velocity of the hot water in the heating pipeline.

In some embodiments, the emergency supervision and management platform may update at least one of the valve opening of the heating pipeline valve or the rotation speed of the circulation pump in the primary network or the secondary network according to the heat exchange abnormality type through a plurality of ways. For example, the emergency supervision and management platform may, based on the heat exchange abnormality type, query a first preset table to determine a device requiring regulation (e.g., the heating pipeline valve or the circulation pump) in the primary network or the secondary network, and update at least one of the valve opening of the heating pipeline valve or the rotation speed of the circulation pump. The first preset table includes a preset relationship between the heat exchange abnormality type and a device requiring regulation, the updated valve opening of the heating pipeline valve, or the updated rotation speed of the circulation pump. The first preset table may be preset by a technician based on experience.

In 250, a heating correlation feature may be determined according to a plurality of historical variation vectors.

The historical variation vectors refer to historical heating variation vectors at a corresponding historical time point when an abnormality occurs in a plurality of heat exchange stations and a plurality of residential areas.

In some embodiments, the historical variation vectors may include a first abnormal heating parameter at a corresponding historical time point. The historical variation vectors may be obtained through routine maintenance records of maintenance personnel.

In some embodiments, for each historical variation vector, the emergency supervision and management platform may, based on historical data, obtain at least one of other abnormal heat exchange stations or abnormal pipeline terminals that appear within a preset time period at the corresponding historical time point, as at least one of associated heat exchange stations or associated pipeline terminals. The emergency supervision and management platform obtains second abnormal heating parameters corresponding to at least one of the associated heat exchange stations or the associated pipeline terminals, and determines a connection relationship between at least one of the associated heat exchange stations or the associated pipeline terminals and at least one of a heat exchange station or a pipeline terminal corresponding to the historical variation vector. For example, the connection relationship includes an upstream relationship, a downstream relationship, or the like.

The heating correlation feature refers to a feature reflecting a correlation relationship between at least one of the abnormal heat exchange station or the abnormal pipeline terminal in the heating pipeline network.

In some embodiments, the heating correlation feature includes a first abnormal heating parameter occurring at a historical time point, a second abnormal heating parameter occurring after the historical time point, and a connection relationship between at least one of the associated heat exchange station or the associated pipeline terminal and at least one of the heat exchange station or the pipeline terminal corresponding to the historical variation vector.

In some embodiments, the emergency supervision and management platform may construct the heating correlation feature based on the first abnormal heating parameter in the historical variation vector, at least one of the associated heat exchange station or the associated pipeline terminal that appears, the corresponding second abnormal heating parameter, and the connection relationship. The preset time period refers to a historical period of a preset duration. The preset time period may be set by a technician based on experience.

In 260, a potential abnormal area at a future time point may be predicted according to the heating variation vector and the heating correlation feature.

The future time point refers to a certain time point after a current time point. The future time point may be set by a technician based on experience. For example, the future time point may be one hour after the current time point, or one day after the current time point.

The potential abnormal area refers to a city area where at least one of the abnormal heat exchange station or the abnormal pipeline terminal may potentially exist in the future.

In some embodiments, the preset interval may be negatively correlated with an area size of the potential abnormal area at the future time point. For example, a larger area of the predicted potential abnormal area at the future time point corresponds to a smaller preset interval. It may be understood that, because the potential abnormal area is predicted in real time, the preset interval may also change dynamically.

In some embodiments, the emergency supervision and management platform may predict the potential abnormal area at the future time point according to the heating variation vector and the heating correlation feature in a plurality of ways. For example, the emergency supervision and management platform may compare the heating variation vector at the current time point with the normal range of the heating parameters to obtain an abnormal heating parameter in the heating variation vector at the current time point. The emergency supervision and management platform may match the abnormal heating parameter at the current time point with the heating correlation feature, predict the potential abnormal area at the future time point based on the connection relationship corresponding to the matched heating correlation feature. Matching refers to comparing the abnormal heating parameter at the current time point with the first abnormal heating parameter. A match is successful when parameter types are consistent. When the match is successful, the emergency supervision and management platform may determine the connection relationship according to the first abnormal heating parameter, determine at least one of the associated heat exchange station or the associated pipeline terminal according to the connection relationship, and designate an area where at least one of the associated heat exchange station or the associated pipeline terminal is located as the potential abnormal area at the future time point.

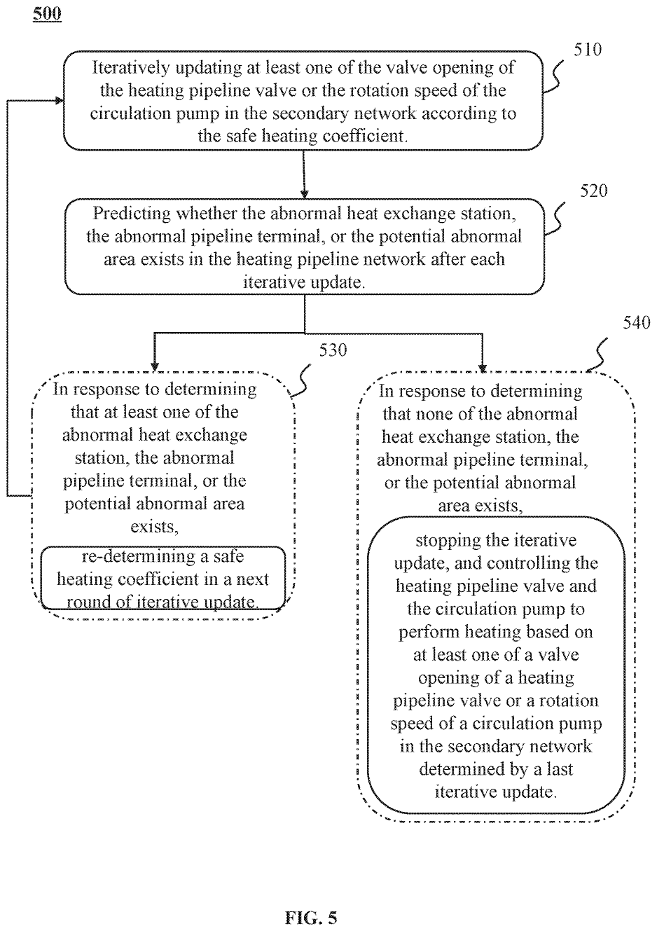

In some embodiments, the emergency supervision and management platform may also predict the potential abnormal area according to an anomaly diffusion model. More details regarding the part may be found in other contents of the present disclosure (e.g., descriptions in connection with FIG. 5).

More details descriptions regarding the normal range of the heating parameters may be found in operation 220 and related content.

In 270, an adjustment time point may be determined according to the potential abnormal area, and the heating pipeline valve and the circulation pump in the secondary network within the potential abnormal area may be controlled to perform heating based on a secondarily adjusted valve opening and a secondarily adjusted rotation speed at the adjustment time point.

The adjustment time point refers to a time point for performing secondary adjustment on an operation device of the heating pipeline network (e.g., the heating pipeline valve and the circulation pump).

In some embodiments, the emergency supervision and management platform may determine the adjustment time point according to the potential abnormal area in a plurality of ways. For example, the emergency supervision and management platform may determine the adjustment time point according to an interval distance between the potential abnormal area and at least one of a current abnormal heat exchange station or a current abnormal pipeline terminal by using a preset rule table. The preset rule table refers to a table including a correspondence relationship between the interval distance and the adjustment time point. The preset rule table may be preset by a technician based on experience. It may be understood that a smaller interval distance corresponds to an earlier adjustment time point.

In some embodiments, the emergency supervision and management platform may also determine the adjustment time point according to regulation fluctuation information. More details regarding the part may be found in other contents of the present disclosure (e.g., descriptions in connection with FIG. 4).

In some embodiments, the secondarily adjusted valve opening and the secondarily adjusted rotation speed refer to adjusted values of the valve opening and the rotation speed corresponding to the heating pipeline valve and the circulation pump, respectively, that require secondary adjustment in the potential abnormal area.

In some embodiments, the emergency supervision and management platform may determine the secondarily adjusted valve opening and the secondarily adjusted rotation speed in a plurality of ways. For example, the emergency supervision and management platform may determine the secondarily adjusted valve opening and the secondarily adjusted rotation speed by querying a second preset table according to heating parameters of the potential abnormal area. The second preset table includes a correlation relationship between the heating parameters of the potential abnormal area and the valve opening of the heating pipeline valve in the secondary network and the rotation speed of the circulation pump in the secondary network. The second preset table may be preset by a technician based on experience. In the second preset table, the heating parameters of the potential abnormal area are average values of a plurality of different types of heating parameters. For example, the heating parameters may include an average value of the heating temperatures, an average value of the heating pressures, an average value of the heating flow rates, or the like.

In some embodiments, the emergency supervision and management platform may also determine the secondarily adjusted valve opening and the secondarily adjusted rotation speed according to a safe heating coefficient. More details regarding the part may be found in other contents of the present disclosure (e.g., descriptions in connection with FIG. 4).

In some embodiments of the present disclosure, on one hand, real-time monitoring of the plurality of heating parameters is employed to identify and address existing issues at the current time point, while historical data analysis is utilized to explore correlations among problems, thereby predicting and proactively intervening in potential future anomalies. Therefore, heating regulation is elevated from passive emergency response to active prevention, ensuring stable and balanced heating. On the other hand, a larger area of the potential abnormal area indicates poorer stability of the current heating pipeline network. Increasing a monitoring frequency for the heating pipeline network for a large-area potential abnormal area can improve accuracy in discovering heating abnormalities.

FIG. 3 is a schematic diagram illustrating an exemplary heating graph structure according to some embodiments of the present disclosure.

In some embodiments, the emergency supervision and management platform may construct a heating graph structure, and determine whether at least one of an abnormal heat exchange station or an abnormal pipeline terminal exists and a heat exchange abnormality type according to the heating graph structure.

The heating graph structure refers to a graph model for describing various components of the heating pipeline network and relationships between each component. In some embodiments, the heating graph structure includes three node types: thermal power plant nodes, heat exchange station nodes, and pipeline terminal nodes. Node attributes include a plurality of heating parameters in each group of a plurality of groups of heating parameters. An edge of the heating graph structure is a heating pipeline. Edge attributes include a pipeline length and a pipe roughness value. The node attributes also include an ambient temperature. The node attributes are updated according to a change of sensor monitoring data. Node attributes of the thermal power plant nodes include a preset temperature. Node attributes of the heat exchange station nodes include a heating temperature, a heating pressure, a heating flow rate, and an ambient temperature of the heat exchange station. Node attributes of the pipeline terminal nodes include a return water temperature, a terminal pressure, a terminal flow rate, and an ambient temperature of a residential area.

In some embodiments, the node attributes may be obtained through sensor monitoring. Exemplary sensors include a temperature sensor, a pressure sensor, a flow sensor, or the like.

In some embodiments, as shown in FIG. 3, the thermal power plant nodes may include a thermal power plant node 310. The heat exchange station nodes may include a heat exchange station node 321 and a heat exchange station node 322. The pipeline terminal nodes may include a pipeline terminal node 331, a pipeline terminal node 332, a pipeline terminal node 333, a pipeline terminal node 334, a pipeline terminal node 335, and a pipeline terminal node 336. The edge of the heating graph structure is the heating pipeline. And a black square on the edge represents at least one of a heating pipeline valve or a circulation pump.

More details regarding the thermal power plant, the heat exchange station, the pipeline terminal, the heating parameter, the heating pipeline, the heating pipeline valve, the circulation pump, and the ambient temperature may be found in other contents of the present disclosure (e.g., descriptions in connection with FIG. 2).

The pipeline length refers to a physical length of the heating pipeline, i.e., a distance from a starting point to an end point of the heating pipeline. For example, the pipeline length is 8 km, 10 km, or the like. The pipeline length may be directly obtained from design drawings or construction drawings of a heating pipeline network.

The pipe roughness value refers to a roughness degree of an inner wall of the heating pipeline, which is usually represented by a roughness coefficient or an equivalent roughness. For example, the pipe roughness value is 0.01 mm, 0.03 mm, or the like. The pipe roughness value may be obtained by querying relevant standards or manuals based on a pipeline material (e.g., steel pipe, plastic pipe, etc.).

The sensor monitoring data refers to each parameter and each indicator reflecting an operating state of the heating pipeline network, which are collected by sensors. For example, the sensor monitoring data includes monitoring values of the node attributes.

In some embodiments, in response to the change of the sensor monitoring data, the emergency supervision and management platform may update values of the node attributes accordingly.

An update of the node attributes may satisfy a preset condition or may not satisfy the preset condition.

In some embodiments, in response to determining that the update of the node attributes satisfy the preset condition, the emergency supervision and management platform may obtain an abnormal node and an anomaly-diffused node corresponding to at least one of the abnormal heat exchange station or the abnormal pipeline terminal according to the heating graph structure through an anomaly diffusion model, and perform a secondary adjustment on at least one of a valve opening of a heating pipeline valve or a rotation speed of a circulation pump in a primary network or a secondary network according to the abnormal node and the anomaly-diffused node.

More details regarding the abnormal heat exchange station, the abnormal pipeline terminal, the primary network, and the secondary network may be found in other contents of the present disclosure (e.g., descriptions in connection with FIG. 2).

The preset condition refers to a preset condition for judging the node attributes. For example, the preset condition includes that an update frequency of the node attributes exceeds a preset frequency threshold and an update amplitude exceeds a preset amplitude threshold. The update frequency refers to a count of times the node attributes change per unit time. For example, the update frequency is 2 times/min, 4 times/min, or the like.

The update amplitude refers to a degree or range of change of the node attributes per unit time. For example, an update amplitude is 0.1 MPa, 0.2 MPa, or the like. In some embodiments, the update amplitude may be represented by an average value of absolute differences between each node attribute before an update and each node attribute after the update. The preset frequency threshold and the preset amplitude threshold refer to preset critical values of an update frequency and an update amplitude, respectively. The preset frequency threshold and the preset amplitude threshold may be set by a technician based on experience.

The anomaly diffusion model refers to a model configured to determine the abnormal node and the anomaly-diffused node. In some embodiments, the anomaly diffusion model is a machine learning model. For example, the anomaly diffusion model is a graph neural network (GNN) model or any other feasible model.

In some embodiments, an input of the anomaly diffusion model is the heating graph structure, and an output includes the abnormal node and the anomaly-diffused node corresponding to at least one of the abnormal heat exchange station or the abnormal pipeline terminal.

In some embodiments, the emergency supervision and management platform may obtain the anomaly diffusion model by training based on a large number of first training samples with first labels.

In some embodiments, the first training sample includes a plurality of historical heating graph structures at different second historical time points when the heating pipeline network is abnormal. The first labels include an actual abnormal node in a historical heating graph structure corresponding to the first training samples and a new abnormal node that appears within a subsequent period of time after a corresponding plurality of second historical time points. The heating pipeline network being abnormal refers to the heating pipeline network having at least one of the abnormal heat exchange station or the abnormal pipeline terminal. The plurality of second historical time points refers to past time points corresponding to a plurality of time points for obtaining the heating parameters. The actual abnormal node refers to a node where at least one of the abnormal heat exchange station or the abnormal pipeline terminal currently appears. The new abnormal node refers to a node where at least one of the abnormal heat exchange station or the abnormal pipeline terminal actually appears within a subsequent period of time in the historical heating graph structure.

Merely by way of example, the emergency supervision and management platform may input the first training samples into an initial anomaly diffusion model, construct a loss function based on an output of the initial anomaly diffusion model and the first labels, and iteratively update parameters of the initial anomaly diffusion model based on the loss function through gradient descent or other manners. When an iteration termination condition is satisfied, model training is completed, and a trained anomaly diffusion model is obtained. The iteration termination condition includes convergence of the loss function, a count of iterations reaching a threshold, etc.

The abnormal node refers to a node where a heating abnormality is detected at a current time point. The heating abnormality refers to the heating parameters not being within a normal range of the heating parameters. More descriptions regarding the normal range of the heating parameters may be found in other contents of the present disclosure (e.g., descriptions in connection with FIG. 2).

In some embodiments, the anomaly-diffused node includes a node predicted to have a heating abnormality at a future time point. In some embodiments, the potential abnormal area includes a plurality of anomaly-diffused nodes.

In some embodiments, for the abnormal node, the emergency supervision and management platform may construct a heating variation vector based on the node attribute of the abnormal node, determine the heat exchange abnormality type based on the abnormal node and the heating variation vecto, and update at least one of the valve opening of the heating pipeline valve or the rotation speed of the circulation pump in the primary network or the secondary network according to the heat exchange abnormality type. More descriptions regarding constructing the heating variation vector, determining the heat exchange abnormality type, and performing the update according to the heat exchange abnormality type may be found in other contents of the present disclosure (e.g., descriptions in connection with FIG. 2).

In some embodiments, for the anomaly-diffused node, the emergency supervision and management platform may determine a spatial position and a front-rear connection relationship of the anomaly-diffused node according to the heating graph structure, cluster the anomaly-diffused nodes according to the spatial positions or the front-rear connection relationships to form a plurality of potential abnormal areas, and determine the adjustment time point according to the plurality of potential abnormal areas. The emergency supervision and management platform may determine a valve opening and a rotation speed for the secondary adjustment through a second preset table according to a plurality of heating parameters of the potential abnormal areas, and at the adjustment time point, perform the secondary adjustment on at least one of the valve opening of the heating pipeline valve or the rotation speed of the circulation pump corresponding to each of the anomaly-diffused nodes. The front-rear connection relationship refers to an upstream-downstream relationship between the anomaly-diffused nodes. Clustering may use a K-means clustering algorithm, a community detection algorithm based on a graph structure, or the like. More details regarding determining the adjustment time point and the second preset table may be found in other contents of the present disclosure (e.g., descriptions in connection with FIG. 2).

In some embodiments of the present disclosure, a graph neural network model is used to analyze the heating graph structure, thereby enabling more intelligent and accurate prediction of a current heating abnormality and a direction of diffusion of the heating abnormality, and achieving precise early warning for a potential fault area.

In some embodiments, the emergency supervision and management platform may determine whether at least one of the abnormal heat exchange station or the abnormal pipeline terminal exists and the heat exchange abnormality type according to the heating graph structure. For example, for one of the pipeline terminal nodes, the emergency supervision and management platform may determine an upstream heat exchange station node of the pipeline terminal node through the heating graph structure, and obtain a difference between a heating temperature of the heat exchange station node and a return water temperature of the pipeline terminal node, a difference between a heating pressure of the heat exchange station node and a terminal pressure of the pipeline terminal node, and a pipeline network resistance factor of an edge between the heat exchange station node and the pipeline terminal node, and construct a first feature vector based on the node attribute of the pipeline terminal node, the two aforementioned differences, and the pipeline network resistance factor. For one of the heat exchange station nodes, the emergency supervision and management platform may find all pipeline terminal nodes downstream of the heat exchange station through the heating graph structure, obtain an average return water temperature, a total downstream demand flow rate, and a maximum temperature difference of the aforementioned plurality of pipeline terminal nodes, and construct a second feature vector according to the node attribute of the heat exchange station node, the aforementioned average return water temperature, the total downstream demand flow rate, and the maximum temperature difference. And the emergency supervision and management platform may obtain at least one of the abnormal heat exchange station or the abnormal pipeline terminal in the heating graph structure and a corresponding heat exchange abnormality type based on cluster analysis.

The pipeline network resistance factor refers to a parameter for describing a magnitude of fluid flow resistance in a heating pipeline, reflecting a degree of obstruction of the heating pipeline to fluid flow. In some embodiments, the emergency supervision and management platform performs normalization processing on the pipeline length and the pipe roughness value, then performs weighted summation, and uses a weighted sum as the pipeline network resistance factor. The normalization processing may be implemented in a plurality of ways. For example, the normalization processing may include Min-Max normalization, or the like. A weight coefficient for the weighted summation may be set by a technician based on experience.

The average return water temperature refers to an average value of return water temperatures of all pipeline terminal nodes downstream of the heat exchange station. For example, all pipeline terminal nodes downstream of the heat exchange station node 321 include pipeline terminal nodes 331 to 333. The average return water temperature is an average value of the return water temperatures of pipeline terminal nodes 331 to 333.

The total downstream demand flow rate refers to a sum of terminal flow rates of all pipeline terminal nodes downstream of the heat exchange station node.

The maximum temperature difference refers to a difference between the heating temperature of the heat exchange station node and a lowest value among the return water temperatures of all pipeline terminal nodes downstream of the heat exchange station node.

An exemplary clustering analysis process includes: constructing a plurality of clustering vectors based on a plurality of historical first vectors and a plurality of historical second vectors corresponding to historical heating graph structures of different heating pipeline networks at a plurality of historical time points; using a historical abnormal heat exchange station, a historical abnormal pipeline terminal, and a corresponding historical heat exchange abnormality type that existed in a heating pipeline network at a historical time point corresponding to a clustering vector as a label corresponding to the clustering vector; constructing a target vector based on a plurality of first feature vectors and a plurality of second feature vectors corresponding to a current heating graph structure; using the plurality of clustering vectors and the target vector as objects to be clustered; performing clustering on the objects to be clustered, and using a cluster where the target vector is located as a target cluster; obtaining a union of nodes corresponding to the historical abnormal heat exchange station and the historical abnormal pipeline terminal in the historical heating graph structures corresponding to the plurality of clustering vectors in the target cluster; using nodes corresponding to the aforementioned nodes in the current heating graph structure as at least one of the abnormal heat exchange station or the abnormal pipeline terminal; and using the historical heat exchange abnormality type corresponding to the clustering vector as the heat exchange abnormality type corresponding to each node in the current heating graph structure.

In some embodiments of the present disclosure, by constructing the entire heating pipeline network into the heating graph structure that includes physical connection relationships and real-time operating parameters, the system can combine topological relationships of the pipeline network when determining abnormalities, thereby more accurately locating the abnormal nodes and identifying the heat exchange abnormality types.

FIG. 4 is a schematic diagram illustrating an exemplary process for determining an adjustment time point according to some embodiments of the present disclosure.

In some embodiments, as shown in FIG. 4, the emergency supervision and management platform may predict regulation fluctuation information 420 based on an ambient temperature 411, a heating temperature 412, a heating pressure 413, a heating flow rate 414, and an adjustment parameter 415 of a heat exchange station, determine an adjustment time point 430 according to the regulation fluctuation information 420, and perform a secondary adjustment on at least one of a valve opening of a heating pipeline valve or a rotation speed of a circulation pump in a secondary network at the adjustment time point 430.

More details regarding the ambient temperature, the heating temperature, the heating pressure, the heating flow rate, the adjustment time point, the secondary network, the heating pipeline valve, the valve opening, the circulation pump, and the rotation speed may be found in other contents of the present disclosure (e.g., descriptions in connection with FIG. 2).

The adjustment parameter refers to a parameter related to attributes of the heating pipeline valve and the circulation pump. For example, the adjustment parameter includes a count of heating pipeline valves to be adjusted, an adjustment amount of the valve opening, a count of circulation pumps to be adjusted, an adjustment amount of the rotation speed, or the like.

The adjustment parameter may be set by a technician based on experience.

The regulation fluctuation information refers to information related to fluctuation of heating parameters.

In some embodiments, the regulation fluctuation information 420 includes a fluctuation amplitude 420-1 and a fluctuation duration 420-2 of a plurality of heating parameters in each group of heating parameters at a plurality of future time points after updating at least one of the valve opening of the heating pipeline valve or the rotation speed of the circulation pump in the primary network or the secondary network.

The plurality of future time points refers to a plurality of time points within a future time period.

The fluctuation amplitude refers to a change amount or a deviation range of the heating parameters after regulation relative to before regulation. For example, the fluctuation amplitude may be a difference between actual values of a plurality of heating parameters monitored by a sensor and a corresponding range in normal heating parameters. The normal heating parameters refer to reasonable ranges for each heating parameter when a heating pipeline network is in a stable operating state. The normal heating parameters may be set by a technician based on experience.

The fluctuation duration refers to a time required for the heating parameters to reach a new stable state after regulation. For example, the fluctuation duration may be a time consumed from a start of adjustment until actual values of a plurality of heating parameters monitored by N consecutive sensors are stabilized within the corresponding range in the normal heating parameters. A value of N may be set by a technician based on experience.

In some embodiments, the emergency supervision and management platform may predict the regulation fluctuation information by retrieving a heating database based on the ambient temperature, the heating temperature, the heating pressure, the heating flow rate, and the adjustment parameter of the heat exchange station. The heating database refers to a database storing a correspondence relationship among the ambient temperature, the heating temperature of the heat exchange station, the heating pressure, the heating flow rate, the adjustment parameter, and the regulation fluctuation information. Merely by way of example, the emergency supervision and management platform may construct a feature vector based on a historical ambient temperature, a historical heating temperature, a historical heating pressure, a historical heating flow rate, and a historical adjustment parameter of the heating pipeline network, use a historical fluctuation amplitude and a historical fluctuation duration of actual historical heating parameters at a corresponding plurality of subsequent time points in a historical regulation corresponding to the feature vector as a label of the feature vector, and repeat the aforementioned operations a plurality of times to obtain the heating database.

In some embodiments, the emergency supervision and management platform may construct a target vector based on a current ambient temperature, a current heating temperature, a current heating pressure, a current heating flow rate, and a current adjustment parameter of the heat exchange station, determine a plurality of vector similarities between the target vector and a plurality of feature vectors in the heating database, select a feature vector with a greatest vector similarity to the target vector, and use a label corresponding to the feature vector as the regulation fluctuation information corresponding to the target vector. The vector similarities may be represented by a cosine similarity, a Euclidean distance, or the like.

In some embodiments, the emergency supervision and management platform may determine the adjustment time point in a plurality of ways based on the regulation fluctuation information. For example, if the fluctuation duration exceeds a preset duration threshold, the emergency supervision and management platform may use a plurality of future time points where the fluctuation amplitude exceeds a preset amplitude threshold as the adjustment time point to perform the secondary adjustment on the heating pipeline network.

The preset duration threshold and the preset amplitude threshold refer to preset critical values for the fluctuation duration and the fluctuation amplitude, respectively. The preset duration threshold and the preset amplitude threshold may be set by a technician based on experience.

In some embodiments, the emergency supervision and management platform may determine a safe heating coefficient according to the regulation fluctuation information in combination with node types, and control the heating pipeline valve and the circulation pump in the secondary network based on the secondarily adjusted valve opening and the secondarily adjusted rotation speed according to at least one of a preset secondarily adjusted valve opening or a preset secondarily adjusted rotation speed of the circulation pump and the safe heating coefficient.

The safe heating coefficient refers to a quantitative indicator for evaluating safety and stability of the heating pipeline network in a current regulation state. For example, the safe heating coefficient may be a numerical value between 0 and 1.

In some embodiments, the emergency supervision and management platform may determine the safe heating coefficient in a plurality of ways based on the regulation fluctuation information and the node types. For example, the emergency supervision and management platform may determine the safe heating coefficient through a third preset table based on an average value of fluctuation amplitudes at the plurality of future time points in the regulation fluctuation information and the node types. The third preset table refers to a table including a correspondence relationship among the average value of the fluctuation amplitudes, the node types, and the safe heating coefficient. The third preset table may be set by a technician based on experience.

In some embodiments, the heat exchange abnormality type includes a heating temperature difference abnormality, a hot water flow abnormality, and a hot water pressure abnormality. The emergency supervision and management platform may determine the safe heating coefficient based on the heat exchange abnormality type corresponding to the regulation fluctuation information and the node types.

In some embodiments, more details regarding the heating temperature difference abnormality, the hot water flow abnormality, and the hot water pressure abnormality may be found in other contents of the present disclosure (e.g., descriptions in connection with FIG. 2).

In some embodiments, the heating temperature difference abnormality, the hot water flow abnormality, and the hot water pressure abnormality correspond to a proportion coefficient, respectively. After determining the safe heating coefficient through the third preset table, the emergency supervision and management platform may use a product of the safe heating coefficient and the proportion coefficient of the heat exchange abnormality type corresponding to the regulation fluctuation information as a current safe heating coefficient. The proportion coefficient may be determined in a plurality of ways. For example, the proportion coefficient may be set by a technician based on experience. As another example, the proportion coefficient is positively correlated to an occurrence frequency of the heat exchange abnormality type within the heating pipeline network. The occurrence frequency refers to a count of occurrences of the heat exchange abnormality type within a certain time period (e.g., one day, one week, or one month).

In some embodiments of the present disclosure, by combining the safe heating coefficient with a specific heat exchange abnormality type (e.g., temperature difference, pressure, flow rate) and a historical occurrence frequency thereof, differentiated regulation strategies of varying intensities are implemented for faults of different natures, thereby making control measures more precise.

It may be understood that at least one of the pre-determined valve opening or the pre-determined rotation speed of the circulation pump after the secondary adjustment refers to at least one of the valve opening or the rotation speed of the circulation pump determined through a second preset table. More details regarding the second preset table may be found in other contents of the present disclosure (e.g., descriptions in connection with FIG. 2).

In some embodiments, the emergency supervision and management platform may use a product of at least one of the preset secondarily adjusted valve opening or the preset secondarily adjusted rotation speed of the circulation pump and the safe heating coefficient as the secondarily adjusted valve opening and the secondarily adjusted rotation speed, and control the heating pipeline valve and the circulation pump in the secondary network to perform heating based on the secondarily adjusted valve opening and the secondarily adjusted rotation speed.

In some embodiments of the present disclosure, by introducing the safe heating coefficient that incorporates post-adjustment expected fluctuations and regional importance, the magnitude of the adjustment instructions is modified. Therefore, safety of regulation operations is ensured, and the excessive impact on a sensitive area is avoided.

In some embodiments of the present disclosure, by leveraging the heating database to predict the parameter fluctuations caused by the adjustment operations prior to the secondary adjustment, the adjustment time point can be selected more scientifically. Therefore, the new system oscillations triggered by arbitrary adjustments is avoided, making the control process more stable.

FIG. 5 is an exemplary flowchart illustrating a process for performing a secondary adjustment on a valve opening and a rotation speed according to some embodiments of the present disclosure.

In some embodiments, as shown in FIG. 5, process 500 includes the following operations. The process 500 may be performed by the emergency supervision and management platform.

In 510, at least one of a valve opening of a heating pipeline valve or a rotation speed of a circulation pump in a secondary network may be iteratively updated according to a safe heating coefficient.

Initial parameters of a first round of iteration are a secondarily adjusted valve opening and a secondarily adjusted rotation speed determined according to the safe heating coefficient. After the first round of iteration is performed, operation 520 is executed. In response to determining that an abnormal heat exchange station, an abnormal pipeline terminal, or a potential abnormal area exists, operation 530 is executed, and the process returns to operation 510 to start a second round of iteration. Initial parameters of the second round of iteration are a secondarily adjusted valve opening and a secondarily adjusted rotation speed determined according to a safe heating coefficient re-determined in the first round of iteration, continuing with operation 520, and so on, proceeding through a plurality of rounds of iterations. In response to determining that none of the abnormal heat exchange station, the abnormal pipeline terminal, or the potential abnormal area exists, operation 540 is executed to end the iteration. More details regarding adjusting at least one of the valve opening of the heating pipeline valve or the rotation speed of the circulation pump in the secondary network based on the safe heating coefficient may be found in other contents of the present disclosure (e.g., descriptions in connection with FIG. 4).

More details regarding the secondary network, the heating pipeline valve, the valve opening, the circulation pump, and the rotation speed may be found in other contents of the present disclosure (e.g., descriptions in connection with FIG. 2).

In 520, it may be predicted whether the abnormal heat exchange station, the abnormal pipeline terminal, or the potential abnormal area exists in the heating pipeline network after each iterative update.

More details regarding the abnormal heat exchange station, the abnormal pipeline terminal, and the potential abnormal area may be found in other contents of the present disclosure (e.g., descriptions in connection with FIG. 2).

In some embodiments, after iteratively updating at least one of the valve opening of the heating pipeline valve or the rotation speed of the circulation pump in the secondary network, the emergency supervision and management platform may update node attributes of a heating graph structure based on a change of sensor monitoring data, construct a heating variation vector simultaneously, determine whether at least one of the abnormal heat exchange station or the abnormal pipeline terminal exists in the heating pipeline network according to the heating graph structure, and predict the potential abnormal area according to the heating variation vector. More details regarding constructing the heating variation vector, determining whether at least one of the abnormal heat exchange station or the abnormal pipeline terminal exists in the heating pipeline network based on the heating graph structure, and predicting the potential abnormal area based on the heating variation vector may be found in other contents of the present disclosure (e.g., descriptions in connection with FIG. 2). More details regarding the heating graph structure may be found in other contents of the present disclosure (e.g., descriptions in connection with FIG. 3).

In some embodiments, the emergency supervision and management platform may, after each iterative update, control the heating pipeline valve and the circulation pump to perform heating based on at least one of the valve opening of the heating pipeline valve or the rotation speed of the circulation pump determined in a current round of iterative update, update the node attributes in the heating graph structure by monitoring, through a sensor, heating parameters after heating is performed based on at least one of the valve opening or the rotation speed after the current round of iterative update, and process the heating graph structure through an anomaly diffusion model to predict whether the abnormal heat exchange station, the abnormal pipeline terminal, or the potential abnormal area exists in the heating pipeline network after each iterative update.

More details regarding the anomaly diffusion model may be found in other contents of the present disclosure (e.g., descriptions in connection with FIG. 3).

In some embodiments of the present disclosure, the graph neural network model is applied in each operation of iterative update. By performing real-time simulation prediction after each fine-tuning, the system can more intelligently evaluate an effect of each adjustment. Therefore, efficiency and accuracy of the iterative optimization process are significantly improved.

Two situations are known: a situation where the abnormal heat exchange station, the abnormal pipeline terminal, or the potential abnormal area exists in the heating pipeline network, and a situation where none of the abnormal heat exchange station, the abnormal pipeline terminal, or the potential abnormal area exists in the heating pipeline network.

In 530, in response to determining that at least one of the abnormal heat exchange station, the abnormal pipeline terminal, or the potential abnormal area exists, the safe heating coefficient may be re-determined in a next round of iterative update.

In some embodiments, in response to determining that the abnormal heat exchange station, the abnormal pipeline terminal, or the potential abnormal area exists in the heating pipeline network, the emergency supervision and management platform may predict regulation fluctuation information according to an ambient temperature, a heating temperature, a heating pressure, a heating flow rate, and an adjustment parameter of the heat exchange station in the current round of iteration, and determine the safe heating coefficient according to the regulation fluctuation information and node types. More details regarding the adjustment parameter, predicting the regulation fluctuation information, and determining the safe heating coefficient may be found in other contents of the present disclosure (e.g., descriptions in connection with FIG. 4).

In some embodiments, after executing operation 530, the emergency supervision and management platform returns to execute operation 510.

In 540, in response to determining that none of the abnormal heat exchange station, the abnormal pipeline terminal, or the potential abnormal area exists, the iterative update may be stopped, and the heating pipeline valve and the circulation pump may be controlled to perform heating based on at least one of a valve opening of the heating pipeline valve or a rotation speed of the circulation pump in the secondary network determined by a last iterative update.

In some embodiments, in response to determining that none of the abnormal heat exchange station, the abnormal pipeline terminal, or the potential abnormal area exists in the heating pipeline network, the emergency supervision and management platform may stop the iterative update, control the heating pipeline valve and the circulation pump to perform heating based on at least one of the valve opening of the heating pipeline valve or the rotation speed of the circulation pump in the secondary network determined in the last iterative update.

In some embodiments of the present disclosure, by re-predicting the system state after each adjustment and deciding whether further adjustments are needed according to the prediction result, a closed-loop control of iterative optimization is formed. Therefore, the system can be adjusted to an optimal state step by step and stably, and a risk of one-step adjustment is avoided.

The basic concepts have been described above. Obviously, for a person skilled in the art, the above detailed disclosure is merely an example and does not constitute a limitation on the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean that a certain feature, structure, or characteristic is related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, unless explicitly stated in the claims, an order of processing elements and sequences, a use of numbers and letters, or a use of other names described in the present disclosure is not used to limit an order of processes and methods of the present disclosure. Although the above disclosure discusses some inventive embodiments currently considered useful through various examples, it should be understood that such details are for illustrative purposes only. The appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

In some embodiments, numbers describing quantities of components and attributes are used. It should be understood that such numbers used to describe the embodiments are modified by a modifier “about,” “approximately,” or “substantially” in some examples. Unless otherwise stated, “about,” “approximately,” or “substantially” indicates that the number allows a variation of ±20%. Accordingly, in some embodiments, numerical parameters used in the specification and the claims are approximate values. The approximate values may vary according to characteristics required by individual embodiments. In some embodiments, the numerical parameters should consider a specified number of signifimayt digits and adopt a general digit retention method. Although numerical ranges and parameters used to confirm a breadth of the ranges in some embodiments of the present disclosure are approximate values, in specific embodiments, such numerical values are set as accurately as possible within a feasible range.

Finally, it should be understood that the embodiments described in the present disclosure are only used to illustrate principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A system for heating emergency regulation in a smart city based on an Internet of Things (IoT) large model, comprising: an emergency supervision and management platform, wherein the emergency supervision and management platform is configured to:
obtain a plurality of groups of heating parameters of a heating pipeline network at a plurality of time points to construct a heating variation vector;
determine whether at least one of an abnormal heat exchange station or an abnormal pipeline terminal exists according to the heating variation vector in combination with an ambient temperature of at least one of a heat exchange station or a residential area;
in response to determining that at least one of the abnormal heat exchange station or the abnormal pipeline terminal exists, determine a heat exchange abnormality type according to the heating variation vector;
update at least one of a valve opening of a heating pipeline valve or a rotation speed of a circulation pump in a primary network or a secondary network according to the heat exchange abnormality type, and control at least one of the heating pipeline valve or the circulation pump to perform heating based on an updated valve opening and an updated rotation speed, wherein the heating includes at least one of conveying hot water by the heating pipeline valve or driving circulation of hot water by the circulation pump;
determine a heating correlation feature according to a plurality of historical variation vectors;
predict a potential abnormal area at a future time point according to the heating variation vector and the heating correlation feature; and
determine an adjustment time point according to the potential abnormal area, and control the heating pipeline valve and the circulation pump in the secondary network within the potential abnormal area to perform heating based on a secondarily adjusted valve opening and a secondarily adjusted rotation speed at the adjustment time point.

2. The system of claim 1, wherein the emergency supervision and management platform is further configured to:
construct a heating graph structure, wherein the heating graph structure includes three node types: thermal power plant nodes, heat exchange station nodes, and pipeline terminal nodes; node attributes include a plurality of heating parameters in each group of the plurality of groups of heating parameters; an edge of the heating graph structure is a heating pipeline; edge attributes include a pipeline length and a pipe roughness value; the node attributes further include the ambient temperature; and the node attributes are updated according to a change of sensor monitoring data; and
determine whether at least one of the abnormal heat exchange station or the abnormal pipeline terminal exists and the heat exchange abnormality type according to the heating graph structure.

3. The system of claim 2, wherein the emergency supervision and management platform is further configured to:
in response to determining that an update of the node attributes satisfies a preset condition,
obtain an abnormal node and an anomaly-diffused node corresponding to at least one of the abnormal heat exchange station or the abnormal pipeline terminal according to the heating graph structure through an anomaly diffusion model, wherein the anomaly-diffused node includes a node predicted to have a heating abnormality at a future time point, and the anomaly diffusion model is a machine learning model; and
perform a secondary adjustment on at least one of the valve opening of the heating pipeline valve or the rotation speed of the circulation pump in the primary network or the secondary network according to the abnormal node and the anomaly-diffused node.

4. The system of claim 1, wherein the emergency supervision and management platform is further configured to:
predict regulation fluctuation information according to the ambient temperature, a heating temperature, a heating pressure, a heating flow rate, and an adjustment parameter of the heat exchange station, wherein the regulation fluctuation information includes a fluctuation amplitude and a fluctuation duration of a plurality of heating parameters of each group of the plurality of groups of heating parameters after updating at least one of the valve opening of the heating pipeline valve or the rotation speed of the circulation pump in the primary network or the secondary network; and
determine the adjustment time point according to the regulation fluctuation information, and perform a secondary adjustment on at least one of the valve opening of the heating pipeline valve or the rotation speed of the circulation pump in the secondary network at the adjustment time point.

5. The system of claim 4, wherein the emergency supervision and management platform is further configured to:
determine a safe heating coefficient according to the regulation fluctuation information in combination with node types; and
control the heating pipeline valve and the circulation pump in the secondary network to perform heating based on the secondarily adjusted valve opening and the secondarily adjusted rotation speed according to at least one of a preset secondarily adjusted valve opening or a preset secondarily adjusted rotation speed of the circulation pump and the safe heating coefficient.

6. The system of claim 5, wherein the emergency supervision and management platform is further configured to:
iteratively update at least one of the valve opening of the heating pipeline valve or the rotation speed of the circulation pump in the secondary network according to the safe heating coefficient;
predict whether the abnormal heat exchange station, the abnormal pipeline terminal, or the potential abnormal area exists in the heating pipeline network after each iterative update;
in response to determining that at least one of the abnormal heat exchange station, the abnormal pipeline terminal, or the potential abnormal area exists, re-determine a safe heating coefficient in a next round of iterative update; and
in response to determining that none of the abnormal heat exchange station, the abnormal pipeline terminal, or the potential abnormal area exists, stop the iterative update, and control the heating pipeline valve and the circulation pump to perform heating based on at least one of a valve opening of a heating pipeline valve or a rotation speed of a circulation pump in the secondary network determined by a last iterative update.

7. The system of claim 6, wherein the emergency supervision and management platform is further configured to:
after each iterative update, control the heating pipeline valve and the circulation pump to perform heating based on at least one of a valve opening of a heating pipeline valve or a rotation speed of a circulation pump determined by the current iterative update;
update node attributes in a heating graph structure according to a heating parameter after performing heating based on at least one of the valve opening or the rotation speed after the current iterative update, which are monitored by a sensor; and
process the heating graph structure through an anomaly diffusion model to predict whether the abnormal heat exchange station, the abnormal pipeline terminal, or the potential abnormal area exists in the heating pipeline network after each iterative update.

8. The system of claim 5, wherein the heat exchange abnormality type includes a heating temperature difference abnormality, a hot water flow abnormality, and a hot water pressure abnormality; and the emergency supervision and management platform is further configured to:
determine the safe heating coefficient according to the heat exchange abnormality type corresponding to the regulation fluctuation information in combination with the node types.

9. A method for heating emergency regulation in a smart city based on an Internet of Things (IoT) large model, wherein the method is executed by an emergency supervision and management platform of a system for heating emergency regulation in a smart city, and the method comprises:
obtaining a plurality of groups of heating parameters of a heating pipeline network at a plurality of time points to construct a heating variation vector;
determining whether at least one of an abnormal heat exchange station or an abnormal pipeline terminal exists according to the heating variation vector in combination with an ambient temperature of at least one of a heat exchange station or a residential area;
in response to determining that at least one of the abnormal heat exchange station or the abnormal pipeline terminal exists, determining a heat exchange abnormality type according to the heating variation vector;
updating at least one of a valve opening of a heating pipeline valve or a rotation speed of a circulation pump in a primary network or a secondary network according to the heat exchange abnormality type, and controlling at least one of the heating pipeline valve or the circulation pump to perform heating based on an updated valve opening and an updated rotation speed, wherein the heating includes at least one of conveying hot water by the heating pipeline valve or driving circulation of the hot water by the circulation pump;
determining a heating correlation feature according to a plurality of historical variation vectors;
predicting a potential abnormal area at a future time point according to the heating variation vector and the heating correlation feature; and
determining an adjustment time point according to the potential abnormal area, and controlling the heating pipeline valve and the circulation pump in the secondary network within the potential abnormal area to perform heating based on a secondarily adjusted valve opening and a secondarily adjusted rotation speed at the adjustment time point.

10. The method of claim 9, wherein the determining whether at least one of an abnormal heat exchange station or an abnormal pipeline terminal exists according to the heating variation vector in combination with an ambient temperature of at least one of a heat exchange station or a residential area includes:
constructing a heating graph structure, wherein the heating graph structure includes three node types: thermal power plant nodes, heat exchange station nodes, and pipeline terminal nodes; node attributes include a plurality of heating parameters in each group of the plurality of groups of heating parameters; an edge of the heating graph structure is a heating pipeline; edge attributes include a pipeline length and a pipe roughness value; the node attributes further include the ambient temperature; and the node attributes are updated according to a change of sensor monitoring data;
determining whether at least one of the abnormal heat exchange station or the abnormal pipeline terminal exists and the heat exchange abnormality type according to the heating graph structure.

11. The method of claim 10, wherein the node attributes are updated according to a change of sensor monitoring data, includes:
in response to determining that an update of the node attributes satisfies a preset condition,
obtaining an abnormal node and an anomaly-diffused node corresponding to at least one of the abnormal heat exchange station or the abnormal pipeline terminal according to the heating graph structure through an anomaly diffusion model, wherein the anomaly-diffused node includes a node predicted to have a heating abnormality at a future time point, and the anomaly diffusion model is a machine learning model; and
performing a secondary adjustment on at least one of the valve opening of the heating pipeline valve or the rotation speed of the circulation pump in the primary network or the secondary network according to the abnormal node and the anomaly-diffused node.

12. The method of claim 9, wherein the determining an adjustment time point according to the potential abnormal area includes:
predicting regulation fluctuation information according to the ambient temperature and a heating temperature, a heating pressure, a heating flow rate, and an adjustment parameter of the heat exchange station, wherein the regulation fluctuation information includes a fluctuation amplitude and a fluctuation duration of a plurality of heating parameters in each group of the plurality of groups of heating parameters after updating at least one of the valve opening of the heating pipeline valve or the rotation speed of the circulation pump in the primary network or the secondary network; and
determining the adjustment time point according to the regulation fluctuation information, and performing a secondary adjustment on at least one of the valve opening of the heating pipeline valve or the rotation speed of the circulation pump in the secondary network at the adjustment time point.

13. The method of claim 12, wherein the determining the adjustment time point according to the regulation fluctuation information, and performing a secondary adjustment on at least one of the valve opening of the heating pipeline valve or the rotation speed of the circulation pump in the secondary network at the adjustment time point includes:
determining a safe heating coefficient according to the regulation fluctuation information and in combination with node types; and
controlling the heating pipeline valve and the circulation pump in the secondary network to perform heating based on the secondarily adjusted valve opening and the secondarily adjusted rotation speed according to at least one of a preset secondarily adjusted valve opening or a preset secondarily adjusted rotation speed of the circulation pump and the safe heating coefficient.

14. The method of claim 13, wherein the controlling the heating pipeline valve and the circulation pump in the secondary network to perform heating based on the secondarily adjusted valve opening and the secondarily adjusted rotation speed according to at least one of a preset secondarily adjusted valve opening or a preset secondarily adjusted rotation speed of the circulation pump and the safe heating coefficient, includes:
iteratively updating at least one of the valve opening of the heating pipeline valve or the rotation speed of the circulation pump in the secondary network according to the safe heating coefficient;
predicting whether the abnormal heat exchange station, the abnormal pipeline terminal, or the potential abnormal area exists in the heating pipeline network after each iterative update;
in response to determining that at least one of the abnormal heat exchange station, the abnormal pipeline terminal, or the potential abnormal area exists, re-determining a safe heating coefficient in a next round of iterative update;
in response to determining that none of the abnormal heat exchange station, the abnormal pipeline terminal, or the potential abnormal area exists, stopping the iterative update, and controlling the heating pipeline valve and the circulation pump to perform heating based on at least one of a valve opening of a heating pipeline valve or a rotation speed of a circulation pump in the secondary network determined by a last iterative update.

15. The method of claim 14, wherein the predicting whether the abnormal heat exchange station, the abnormal pipeline terminal, or the potential abnormal area exists in the heating pipeline network after each iterative update, includes:
after each iterative update, controlling the heating pipeline valve and the circulation pump to perform heating based on at least one of a valve opening of a heating pipeline valve or a rotation speed of a circulation pump determined by the current iterative update;
updating node attributes in a heating graph structure according to a heating parameter after performing heating based on at least one of the valve opening or the rotation speed after the current iterative update, which are monitored by a sensor; and
processing the heating graph structure through an anomaly diffusion model to predict whether the abnormal heat exchange station, the abnormal pipeline terminal, or the potential abnormal area exists in the heating pipeline network after each iterative update.

16. The method of claim 13, wherein the heat exchange abnormality type includes a heating temperature difference abnormality, a hot water flow abnormality, and a hot water pressure abnormality; and the determining a safe heating coefficient according to the regulation fluctuation information and in combination with node types, includes:
determining the safe heating coefficient according to the heat exchange abnormality type corresponding to the regulation fluctuation information in combination with the node types.

17. A non-transitory computer-readable storage medium storing computer instructions, wherein when a computer reads the computer instructions in the storage medium, the computer executes the method for smart city heating emergency regulation of claim 9.
